(19) United States
(12) Patent Application Publication
(10) Pub. No.: US 2010/0211276 A1
(43) Pub. Date: Aug. 19, 2010

(54) CONTROL DEVICE FOR AUTOMATIC TRANSMISSION

(76) Inventors: Takaaki Tokura, Aichi-ken (JP); Nobufusa Kobayashi, Aichi-ken (JP); Tomohiro Asami, Aichi-ken (JP); Hideaki Otsubo, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/679,962

(22) PCT Filed: Sep. 30, 2008
(86) PCT No.: PCT/JP2008/067725

§ 371 Date: Mar. 25, 2010

(30) Foreign Application Priority Data
Oct. 1, 2007 (JP) 2007-257443

(51) Int. Cl. G06F 19/00

(52) U.S. Cl. 701/58

(57) ABSTRACT

In order to realize favorable transmission characteristics in power-off upshift in clutch-to-clutch shift, an ECU detects an upshift request in a power-off state (request of clutch-to-clutch shift), and then outputs a control signal to a hydraulic circuit such that an on-coming clutch is engaged. When the on-coming clutch torque capacity becomes larger than 0 to have transmission torque, a sweep-down control signal is output to the hydraulic circuit such that an off-going clutch is released.

### TECHNICAL FIELD

The present invention relates to a control device for an automatic transmission mounted on a vehicle, particularly, a control device for controlling clutch-to-clutch shift favorably.

### BACKGROUND ART

An automatic transmission mounted on a vehicle is configured based on a combination of a torque converter to which engine output is applied, and a gear type transmission mechanism driven by an output from the torque converter. The power transmission path of this gear type transmission is switched by selective engagement and release of a plurality of frictional engagement elements such as a clutch and brake, allowing automatic shifting to a predetermined gear according to a driver's request and/or driving state.

In such automatic transmission, there is a case where the speed is changed by switching the engagement of the frictional engagement elements based on control of engaging and control of releasing different frictional engagement elements concurrently (the so-called clutch-to-clutch shift). In such clutch-to-clutch shift, favorable shift properties are realized by achieving a balance between the engaging timing and releasing timing of both clutches (for example, comfortable sense of gear shifting for the driver while avoiding shift shock).

Japanese Patent Laying-Open No. 6-323415 (Patent Document 1) discloses an automatic transmission allowing proper determination of a positive or negative input torque towards the automatic transmission, i.e. whether in a power-on drive (positive) or inertia drive (negative), in clutch-to-clutch shift control, to execute suitable shift control based on the determination result. The automatic transmission implements a gear ratio of multi-stages by switching the torque transmission path through torque transmission path switching elements, and allows control of the transmission torque of the torque transmission path switching elements in an arbitrary manner. The automatic transmission includes an output torque detector to detect the output torque of the torque transmission path, a positive/negative torque determinator to determine whether the torque input to the torque transmission path is positive/negative from the polarity of the output torque detected by the output torque detector, and a switching element change control logic modifier responsive to the positive/negative input torque determined by the positive/negative torque determinator to, when the input torque is positive, first couple and drive a torque transmission path switching element that is to be coupled in speed change, and then disengage the torque transmission path switching element to be released in speed change at the end of the torque phase, and when the input torque is negative, first disengage the torque transmission path switching element to be released, and then couple the torque transmission path switching element to be engaged.

According to this automatic transmission, the switching element change control logic modifier in clutch-to-clutch shift responds to a positive or negative input torque (power-on drive or inertia drive) determined by the positive/negative torque determinator to execute the switching element change control logic of, when the input torque is positive, first coupling and driving a torque transmission path switching element that is to be coupled in speed change, and then disengaging the torque transmission path switching element to be released at this change of speed at the end of the torque phase, and when the input torque is negative, first disengaging the torque transmission path switching element to be released, and then coupling the torque transmission path switching element to be engaged. Thus, smooth gear shifting without shock is allowed when running in both a power-on mode and in an inertia mode.

In addition, Japanese Patent Laying-Open No. 2004-60771 (Patent Document 2) discloses a shift control device for an automatic transmission and a designing method thereof, allowing a favorable sense of gear shifting.

Patent Document 1: Japanese Patent Laying-Open No. 6-323415

Patent Document 2: Japanese Patent Laying-Open No. 2004-60771

### DISCLOSURE OF THE INVENTION

### Problems to be Solved by the Invention

When determination is made of running in the inertia mode at the time of upshift under the clutch-to-clutch control in the automatic transmission of Patent Document 1, first the torque transmission path switching element to be released is disengaged, and then the torque transmission path switching element to be engaged is coupled. Therefore, an event of the oil pressure not being supplied to both the off-going friction element and the on-coming friction element occurs, as shown in FIG. 3 of Patent Document 1. When the accelerator pedal is stepped on at this stage, turbine racing (engine racing) will occur since both the off-going friction element and on-coming friction element do not have torque capacity, disallowing favorable shifting (changing speed in a short shifting duration without shift shock).

Further, since the start of the inertia phase in clutch-to-clutch shift was determined based on the controlled oil pressure of the on-coming friction element in the automatic transmission including those disclosed in Patent Documents 1 and 2, it was difficult to control at high accuracy the inertia phase time (and in turn, the time required for speed change).

In view of the foregoing, an object of the present invention is to provide a control device for an automatic transmission that can particularly realize favorable speed-change characteristics during power-off upshift in engagement-switching shift (clutch-to-clutch shift).

### Means for Solving the Problems

A control device according to the present invention is for an automatic transmission that executes engagement-switching shift by controlling the release and engagement of different frictional engagement elements. The control device includes an off-going side oil pressure controller controlling oil pressure of an off-going frictional engagement element, an on-coming side oil pressure controller controlling oil pressure of an on-coming frictional engagement element, and a control unit controlling the off-going side oil pressure controller and on-coming side oil pressure controller. The control unit determines whether the on-coming frictional engagement element is in a state having torque capacity, and detects a request for engagement-switching shift. When a request for engagement-switching shift is detected, the off-going frictional engagement element is released until the coupling force of the off-going frictional engagement element attains a predetermined off-going side coupling force, while the on-coming frictional engagement element is engaged until the coupling force of the on-coming frictional engagement element attains a predetermined on-coming side coupling force. When determination is made that the on-coming frictional engagement element is in a state having torque capacity, the coupling force of the off-going frictional engagement element is further reduced lower than the predetermined off-going side coupling force.

According to the present invention, in the event of detecting an engagement-switching shift request of clutch-to-clutch, for example, the off-going frictional engagement element is released until the coupling force of the off-going frictional engagement element attains the predetermined off-going side coupling force (for example, the coupling force to immediately sweep down to set the torque capacity to less than or equal to 0 without causing the automatic transmission to attain a neutral state), while the on-coming frictional engagement element is engaged until the coupling force of the on-coming frictional engagement element attains the predetermined on-coming side coupling force (for example, the coupling force where the torque capacity is greater than 0). The timing of further releasing the off-going frictional engagement element (the timing of further reducing the coupling force) is when determination is made that the on-coming frictional engagement element has torque capacity. Since the event of both the off-going frictional engagement element and on-coming frictional engagement element attaining a state of not having torque capacity during shift control is eliminated, the engine speed will not be boosted suddenly (no engine racing and/or turbine racing) even if the stepping on the accelerator is increased during shift control. Further, since the turbine speed will be reduced when the on-coming frictional engagement element has torque capacity, the inertia phase can be shortened to reduce the shift duration, as compared to the engagement operation to cause the on-coming frictional engagement element to have torque capacity after the off-going frictional engagement element is released. As a result, there can be provided a control device for an automatic transmission that can realize favorable shifting characteristics in engagement-switching shift (clutch-to-clutch shift).

Preferably, the predetermined off-going side coupling force includes a level at which the off-going frictional engagement element does not slip when the on-coming frictional engagement element does not have torque capacity.

According to the present invention, the engine speed will not be boosted suddenly (no engine racing and/or turbine racing) even if the stepping on the accelerator is increased during shift control since the off-going side coupling force of the off-going frictional engagement element is equal to a level at which the off-going frictional engagement element does not slip when the on-coming frictional engagement element does not have torque capacity.

Further preferably, the predetermined off-going side coupling force includes a level at which the automatic transmission does not attain neutral when the on-coming frictional engagement element does not have torque capacity.

According to the present invention, the engine speed will not be boosted suddenly (no engine racing and/or turbine racing) even if the stepping on the accelerator is increased during shift control since the coupling force of the off-going frictional engagement element is equal to a level at which the automatic transmission does not attain neutral when the on-coming frictional engagement element does not have torque capacity.

Further preferably, the automatic transmission is coupled with an engine. The control unit detects a state of the engine to control the off-going side oil pressure controller and on-coming side oil pressure controller when the engine is in any of a driven state and a light driving state.

In accordance with the present invention, there is a possibility of tie-up to cause shift shock when the automatic transmission attains a state other than the neutral state, and both the on-coming and off-going frictional engagement elements have transmission torque. The off-going side oil pressure controller and on-coming side oil pressure controller are controlled by the control unit of the present invention under the restriction to any of the cases of a driven state and a light driving state (light driven state) that are states of the engine where the effect of tie-up does not occur or can be ignored. Thus, the problem of tie-up is eliminated.

Further preferably, the control unit detects upshift in a power-off state.

According to the present invention, rapid speed change without shock can be realized in upshift under a power-off (accelerator off) state.

### BRIEF DESCRIPTION OF THE DRAWINGS

FIG. 1 is a schematic diagram of a configuration of a vehicle powertrain incorporating an automatic transmission under control of a control device of the present embodiment.

FIG. 2 is a skeleton diagram of a planetary gear unit of an automatic transmission.

FIG. 3 represents an operation table of the automatic transmission.

FIG. 4 is a flowchart of a control configuration of a program executed by an ECU identified as a control device for an automatic transmission of the present embodiment.

FIG. 5 is a timing chart of an operation of the automatic transmission when the program of FIG. 4 is executed.

FIG. 6 is a timing chart of an operation of an automatic transmission compared to the present invention.

### DESCRIPTION OF THE REFERENCE CHARACTERS

300 input I/F, 400 processing unit, 402 power-on downshift processor, 404 gear determination unit, 406 oil pressure correction processor, 408 sweep controller, 500 storage unit, 600 output I/F, 1000 engine, 2000 automatic transmission, 2100 torque converter, 3000 planetary gear set, 3100 front planetary gear, 3200 rear planetary gear, 3301 C1 clutch, 3302 C2 clutch, 3303 C3 clutch, 3304 C4 clutch, 3311 B1 brake, 3312 B2 brake, 3320 one-way clutch, 4000 hydraulic circuit, 8000 ECU, 8002 ROM, 8004 shift lever, 8006 position switch, 8008 accelerator pedal, 8010 accelerator pedal position sensor, 8012 brake pedal, 8014 step-on sensor, 8016 electronic throttle valve, 8018 throttle position sensor, 8020 engine speed sensor, 8022 input shaft speed sensor, 8024 output shaft speed sensor, 8026 oil temperature sensor, 8028 coolant temperature sensor, 8100 engine ECU, 8200 ECT_ECU.

### BEST MODES FOR CARRYING OUT THE INVENTION

Embodiments of the present invention will be described hereinafter with reference to the drawings. In the description, the same components have the same reference characters allotted. Their designation and function are also identical. Therefore, detailed description thereof will not be repeated.

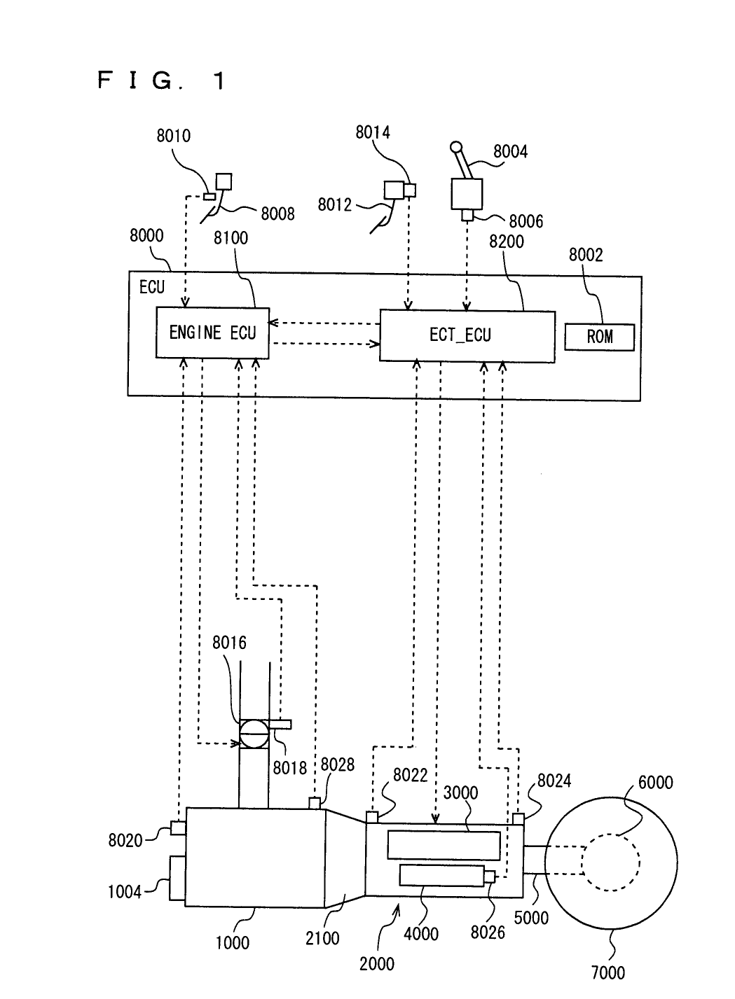

A vehicle incorporating a control device according to an embodiment of the present invention will be described with reference to FIG. 1. This vehicle is an FR (Front engine Rear drive) vehicle. A vehicle other than the FR type may be employed.

The vehicle includes an engine 1000, an automatic transmission 2000, a propeller shaft 5000, a differential gear 6000, a rear wheel 7000, and an ECU (Electronic Control Unit) 8000. Automatic transmission 2000 includes a torque converter 2100, a gear set formed of a planetary gear unit 3000, and a hydraulic circuit 4000. The control device of the present embodiment is realized by executing a program recorded in, for example, a ROM (Read Only Memory) 8002 of ECU 8000.

Engine 1000 is an internal combustion engine for combusting an air-fuel mixture injected from an injector (not shown) and the air in a combustion chamber of a cylinder. A piston in the cylinder is pushed down by the combustion, whereby the crankshaft is rotated. Auxiliary equipment 1004 such as an alternator and air conditioner is driven by the driving force of engine 1000. A motor may be used as the power source instead of or in addition to engine 1000.

The input shaft of torque converter 2100 is coupled to the output shaft of engine 1000. Automatic transmission 2000 changes the revolution speed of the crankshaft to the desired speed by establishing a desired gear configuration.

The driving force output from automatic transmission 2000 is transmitted to the left and right rear wheels 7000 via propeller shaft 5000 and differential gear 6000.

ECU 8000 is connected to, via a harness or the like, a position switch 8006 of a shift lever 8004, an accelerator pedal position sensor 8010 of an accelerator pedal 8008, a step-on sensor 8014 of a brake pedal 8012, a throttle opening position sensor 8018 of an electronic throttle valve 8016, an engine speed sensor 8020, an input shaft speed sensor 8022, an output shaft speed sensor 8024, an oil temperature sensor 8026, and a coolant temperature sensor 8028.

The position of shift lever 8004 is detected by position switch 8006, and a signal representing a detection result is transmitted to ECU 8000. The gear configuration of automatic transmission 2000 is set automatically corresponding to the position of shift lever 8004. Further, a configuration of selecting a manual shift mode in which the driver can select an arbitrary gear in response to the driver's operation may be employed.

Accelerator pedal position sensor 8010 detects the position of accelerator pedal 8008 to transmit a signal representing the detection result to ECU 8000. Step-on sensor 8014 detects the stepping on brake pedal 8012 (the step-on level on brake pedal 8012 by the driver) to transmit a signal representing the detection result to ECU 8000.

Throttle opening position sensor 8018 detects the opening of electronic throttle valve 8016 having the opening adjusted by an actuator to transmit a signal representing the detection result to ECU 8000. The amount of air introduced into engine 1000 (engine 1000 output) is adjusted by electronic throttle valve 8016.

Instead of or in addition to electronic throttle valve 8016, the amount of air admitted into engine 1000 may be adjusted by modifying the lifting and/or opening/closing phase of an intake valve (not shown) and/or exhaust valve (not shown).

Engine speed sensor 8020 detects the revolution speed of the output shaft (crankshaft) of engine 1000 to transmit a signal representing the detection result to ECU 8000. Turbine speed sensor 8022 detects a turbine speed NT of torque converter 2100 to transmit a signal representing the detection result to ECU 8000. Output shaft speed sensor 8024 detects an output shaft speed NO of automatic transmission 2000 to transmit a signal representing the detection result to ECU 8000.

Oil temperature sensor 8026 detects the temperature (oil temperature) of the oil (ATF: Automatic Transmission Fluid) employed in the operation and/or lubrication of automatic transmission 2000 to transmit a signal representing the detection result to ECU 8000.

Coolant temperature sensor 8028 detects the temperature (coolant temperature) of the cooling water of engine 1000 to transmit a signal representing the detection result to ECU 8000.

ECU 8000 controls various equipment such that the vehicle can take a desired running state based on signals transmitted from position switch 8006, accelerator pedal position sensor 8010, step-on sensor 8014, throttle position sensor 8018, engine speed sensor 8020, input shaft speed sensor 8022, output shaft speed sensor 8024, oil temperature sensor 8026, coolant temperature sensor 8028 and the like, as well as a map and program stored in ROM 8002.

When shift lever 8004 is at a D (drive) position in the present embodiment, ECU 8000 controls automatic transmission 2000 to form any of the first to eighth forward gears. By the formation of any of the first to eighth forward gears, automatic transmission 2000 can transmit the driving power to rear wheel 7000. A gear configuration faster than the eighth gear may be implemented at the D position. The gear configuration to be formed is determined based on a shifting diagram prepared in advance through experiments and the like based on the vehicle speed and accelerator pedal position as parameters.

As shown in FIG. 1, ECU 8000 includes an engine ECU 8100 controlling engine 1000, and an ECT (Electronic Controlled Transmission)_ECU 8200 controlling automatic transmission 2000.

Engine ECU 8100 and ECT_ECU 8200 are configured to allow mutual transmission and reception of a signal. In the present embodiment, a signal representing the accelerator pedal position is transmitted from engine ECU 8100 to ECT_ECU 8200. A signal representing a torque demand determined as the torque to be output from engine 1000 is transmitted from ECT_ECU 8200 to engine ECU 8100.

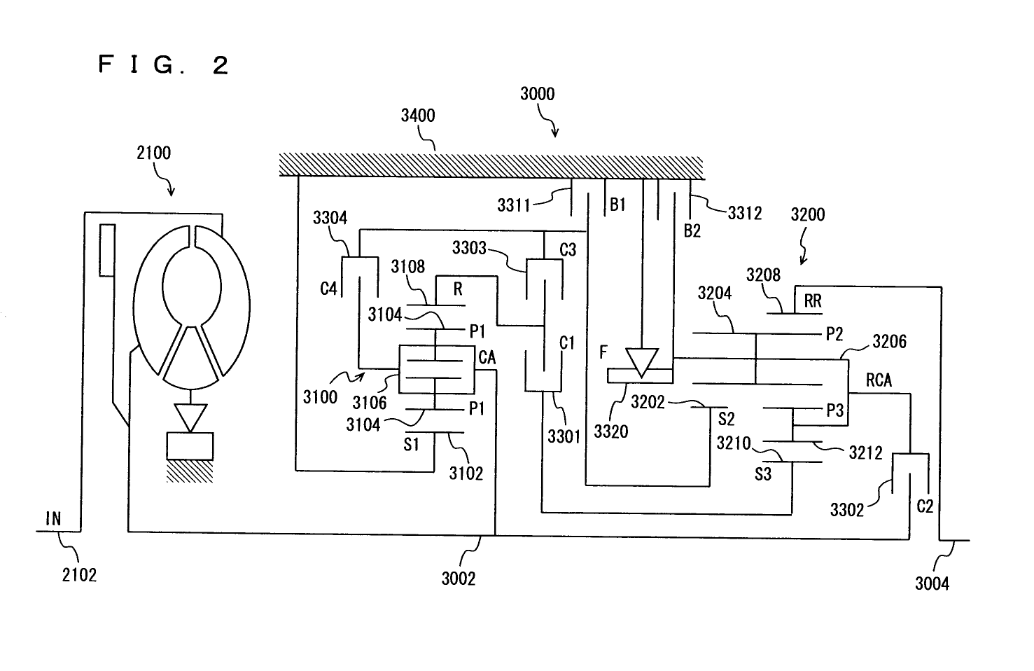

With reference to FIG. 2, planetary gear unit 3000 will be described. Planetary gear unit 3000 is connected to torque converter 2100 having an input shaft 2102 coupled to the crankshaft.

Planetary gear unit 3000 includes a front planetary gear 3100, a rear planetary gear 3200, a C1 clutch 3301, a C2 clutch 3302, a C3 clutch 3303, a C4 clutch 3304, a B1 brake 3311, a B2 brake 3312, and a one-way clutch (F) 3320.

Front planetary gear 3100 is a planetary gear set of a double pinion type. Front planetary gear 3100 includes a first sun gear (S1) 3102, a pair of first pinion gears (P1) 3104, a carrier (CA) 3106, and a ring gear (R) 3108.

First pinion gears (P1) 3104 are meshed with first sun gear (S1) 3102 and first ring gear (R) 3108. First carrier (CA) 3106 supports first pinion gears (P1) 3104 such that first pinion gears (P1) 3104 take an orbital motion while turning on their own axes.

First sun gear (S1) 3102 is fixed to a gear case 3400, disabled in rotation. First carrier (CA) 3106 is coupled to an input shaft 3002 of planetary gear unit 3000.

Rear planetary gear 3200 is a Ravigneaux type planetary gear set. Rear planetary gear 3200 includes a second sun gear (S2) 3202, a second pinion gear (P2) 3204, a rear carrier (RCA) 3206, a rear ring gear (RR) 3208, a third sun gear (S3) 3210, and a third pinion gear (P3) 3212.

Second pinion gear (P2) 3204 is meshed with second sun gear (S2) 3202, rear ring gear (RR) 3208, and third pinion gear (P3) 3212. Third pinion gear (P3) 3212 is meshed with third sun gear (S3) 3210 in addition to second pinion gear (P2) 3204.

Rear carrier (RCA) 3206 supports second pinion gear (P2) 3204 and third pinion gear (P3) 3212 such that they take an orbital motion while turning on their own axes. Rear carrier (RCA) 3206 is coupled to one-way clutch (F) 3320. Rear carrier (RCA) 3206 cannot be rotated when driving in the first gear (when the vehicle runs by using the drive force from engine 1000). Rear ring gear (RR) 3208 is coupled to an output shaft 3004 of planetary gear unit 3000.

One-way clutch (F) 3320 is provided in parallel to B2 brake 3312. That is, an outer race of one-way clutch (F) 3320 is fixed to gear case 3400, and an inner race is coupled to rear carrier (RCA) 3206.

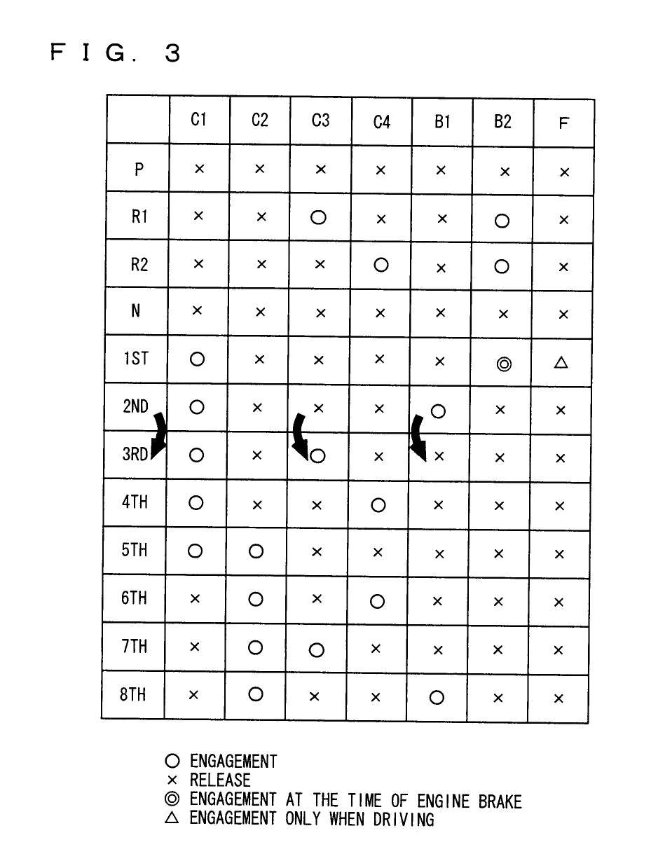

FIG. 3 shows an operation table representing a relationship between each gear and the working states of each of the clutches and brakes. First to eighth forward gears as well as first and second reverse gears are implemented by actuating the brakes and the clutches in the combination shown in this operation table.

In the control device of the present embodiment, the functional effect is particularly significant in the upshift of clutch-to-clutch (particularly, power-off upshift) from the second gear to the third gear, for example, as indicated by an arrow. At this stage, clutch-to-clutch shift is implemented in which C3 clutch 3303 attains an engaged state from a released state, and B1 brake 3311 attains a released state from an engaged state.

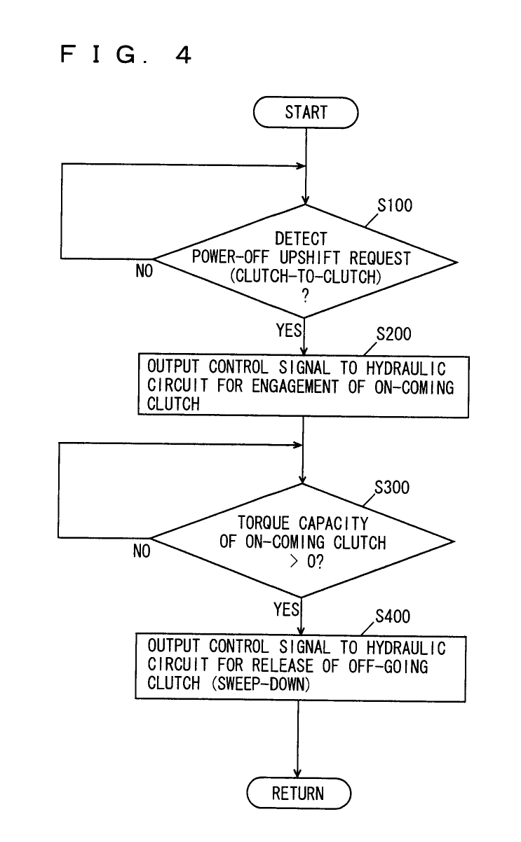

Referring to FIG. 4, a control configuration of a program executed at ECT_ECU 8200 identified as a control device of the present embodiment will be described. The program represented by the flowchart of FIG. 4 is a subroutine program, executed repeatedly at a predetermined cycle time. This program may also be executed by ECU 8000.

At step (step abbreviated as S hereinafter) 100, ECT_ECU 8200 determines whether an upshift request (clutch-to-clutch shift) in a power-off state has been detected or not. At this stage, ECT_ECU 8200 determines whether the vehicle is in a power-off state or not based on the direct signals from accelerator pedal position sensor 8010 and throttle position sensor 8018 received from engine ECU 8100, and/or reception of a flag indicating a power-off state based on the determination of a power-off state made by engine ECU 8100 according to the received signals. An upshift request (clutch-to-clutch) is identified based on the engagement table of FIG. 3 and the signal applied from position switch 8006 to determine whether an upshift request of clutch-to-clutch has been detected or not. When an upshift request (clutch-to-clutch shift) in a power-off state is detected (YES at S100), control proceeds to S200; otherwise (NO at S100), control returns to S100 to wait for detection of an upshift request (clutch-to-clutch shift) in a power-off state.

At S200, ECT_ECU 8200 outputs a control signal (designation pressure of controlled oil pressure) to hydraulic circuit 4000 such that the on-coming clutch (for example, C3 clutch 3303) is engaged. At this stage, the off-going clutch (for example, B1 brake 3311) is not slip-controlled, and the sweep-down is controlled such that slipping is initiated at the timing of the torque capacity of the on-coming clutch becoming greater than 0.

At S300, ECT_ECU 8200 determines whether the torque capacity of the on-coming clutch is greater than 0 or not. ECT_ECU 8200 has stored, as an expected value, the generation timing of the torque capacity of the on-coming clutch determined in advance, corresponding to a control signal (controlled designation oil pressure) output to hydraulic circuit 4000 at S200. Determination is made as to whether the torque capacity of the on-coming clutch is greater than 0 or not based on the expected value, for example, when the expected value is defined in connection with time, based on the elapsed time from the point of time of output of a control signal (controlled oil pressure designation pressure) to hydraulic circuit 4000. When determination is made that the torque capacity of the on-coming clutch is greater than 0 (YES at S300), control proceeds to S400; otherwise (NO at S300), control returns to S300 to wait for the torque capacity of the on-coming clutch to become greater than 0 (until the expected point of time of the torque capacity becoming greater than 0).

At S400, ECT_ECU 8200 outputs a control signal (controlled oil pressure designation pressure) to hydraulic circuit 4000 such that the off-going clutch (for example, B1 brake 3311) is released. At this stage, sweep-down control is effected such that the controlled oil pressure is gradually reduced.

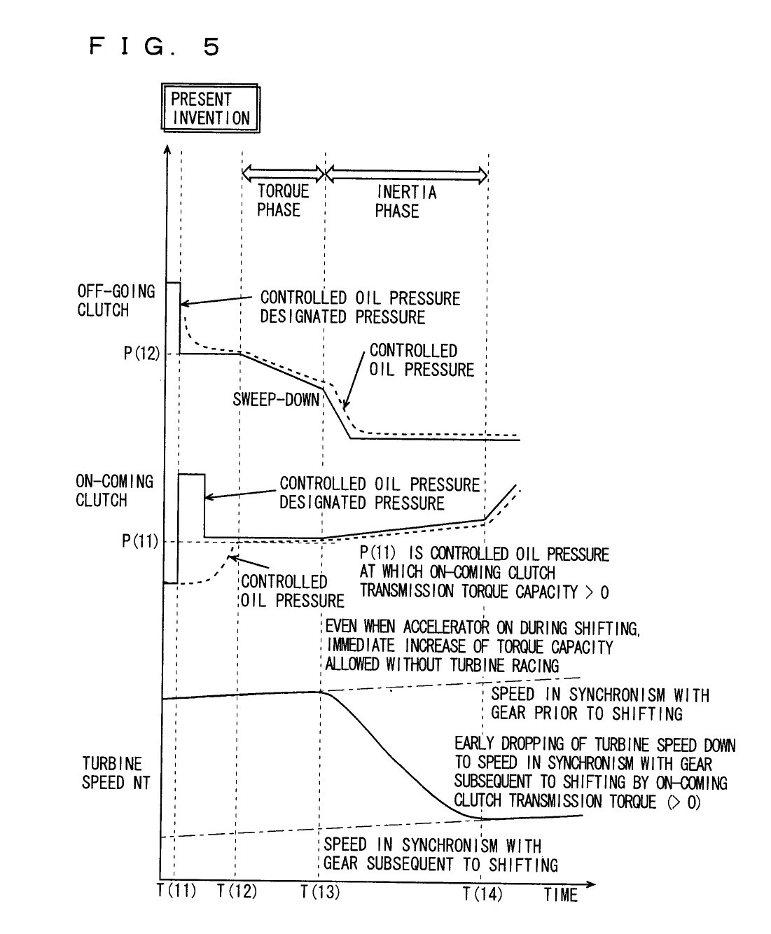

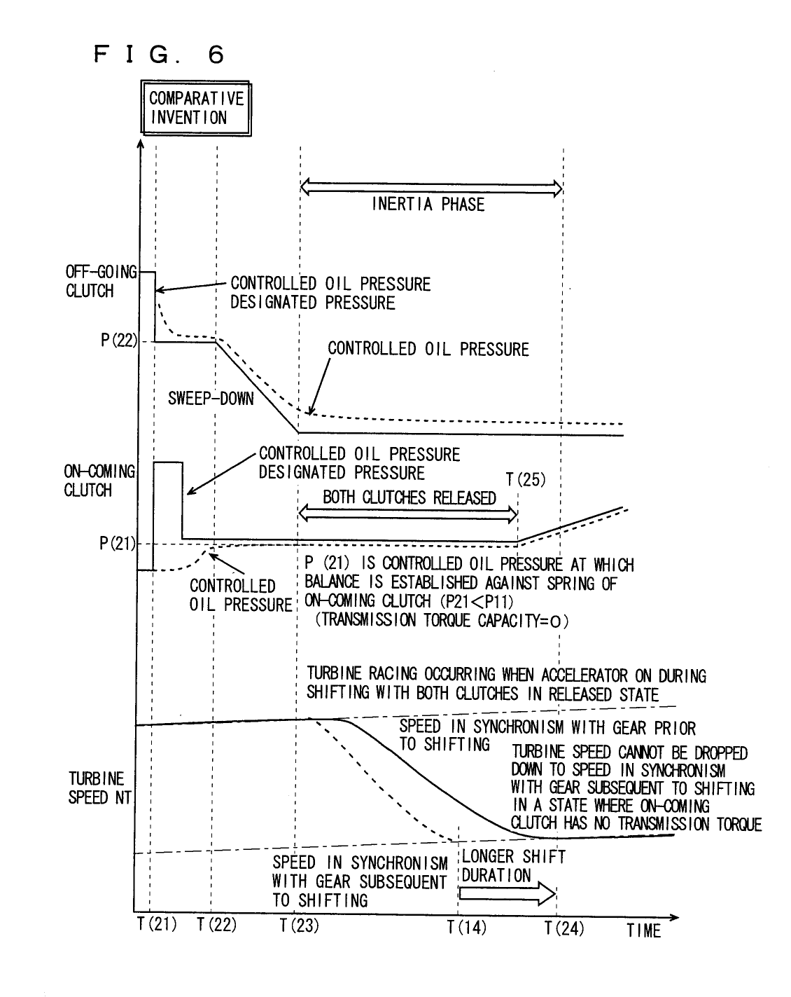

An operation of a vehicle incorporating automatic transmission 2000 under control of the control device of the present embodiment based on the configuration and flowchart set forth above will be described hereinafter with reference to FIG. 5 (present invention) and FIG. 6 (comparative invention).

When power-off upshift is detected in a clutch-to-clutch shift from the second gear to the third gear, as indicated by an arrow in FIG. 3 (YES at S100), a controlled oil pressure designation pressure is output to the hydraulic circuit such that the on-coming clutch is engaged (time T (11) in FIG. 5). At an elapse of the transition period, a controlled oil pressure designation pressure is output such that the controlled oil pressure of the on-coming clutch attains the level of P (11). At this stage, the off-going clutch is controlled to maintain a controlled oil pressure P (12) at which the clutch does not slip. This controlled oil pressure P (12) is preferably set at a level at which the shift shock by tie-up is negligible.

At time T (12) (this time corresponds to the time when the torque capacity of the on-coming clutch becomes greater than 0 is added to time T (11) in the case where controlled oil pressure is output to hydraulic circuit 4000 such that the on-coming clutch is engaged, as shown in FIG. 5), the torque capacity of the on-coming clutch becomes greater than 0 (YES at S300). Namely, when controlled oil pressure designation pressure is output to hydraulic circuit 4000 to establish engagement of the on-coming clutch, as shown in FIG. 5, the torque capacity of the on-coming clutch becomes larger than 0 at time T (12). Thus, the on-coming clutch will have transmission torque.

From T (12), the controlled oil pressure designation pressure for the on-coming clutch is output to hydraulic circuit 4000 such that the controlled oil pressure of the on-coming clutch maintains the level of P (11), while the controlled oil pressure designation pressure of the off-going clutch is output to hydraulic circuit 4000 such that the controlled oil pressure of the off-going clutch sweeps down from the level of P (12) (S400).

Accordingly, the torque capacity of the on-coming clutch becomes greater than 0 so as to have transmission torque at time T (12), which causes turbine speed NT to be promptly lowered to the speed in synchronism with the gear subsequent to shifting (in this case, third gear). As a result, the duration of the inertia phase, subsequent to transition from the torque phase to the inertia phase at time T (13), can be shortened. As shown in FIG. 5, the inertia phase ends and shifting is completed at time T (14).

Since the torque capacity of at least one of the on-coming clutch and off-going clutch is greater than 0 (oil pressure is supplied to at least one of the clutches) during shifting from time T (11) to time T (14), turbine racing (sudden boost of turbine speed NT) can be avoided even if the stepping on accelerator pedal 8008 by the driver is increased during shifting. Thus, shift shock and/or lag in the shifting duration can be avoided.

Control is performed such that the controlled oil pressure of the off-going clutch attains the level of P (12) (the setting of this P (12) is as set forth above) upon detection of a gear shift command, and the controlled oil pressure of the off-going clutch is swept down with the timing of the torque capacity of the on-coming clutch becoming larger than 0 (time T (12) in FIG. 5) as the starting point. Therefore, the shift shock by tie-up can be prevented.

FIG. 6 represents the timing chart of the operation of a vehicle corresponding to a comparative invention. With regards to the time axis, T (11), T (12) and T (13) correspond to T (21), T (22), and T (23), respectively. It is to be noted that T (24) of FIG. 6 is behind T (14) of FIG. 5.

The most significant difference between FIGS. 5 and 6 lies in that the controlled oil pressure designation pressure of the on-coming clutch boosted from time T (21) such that the on-coming clutch is engaged is at the level of P (21) lower than P (11) at that stage (after time T (22)). This controlled oil pressure P (21) is only of a level that can achieve a balance with the reactive force of a spring or the like, against the spring in the oil pressure chamber of the on-coming clutch. In other words, the torque capacity is less than or equal to 0, and the on-coming clutch does not have transmission torque. Therefore, the torque capacity of the on-coming clutch will become greater than 0 so as to have transmission torque only when the off-going clutch is completely released, after time T (25) when the controlled oil pressure designation value of the on-coming clutch begins to rise.

Accordingly, the duration of the on-coming clutch in a state not having transmission torque becomes longer than that of the present invention. Turbine speed NT cannot be promptly reduced down to the speed in synchronism with the gear subsequent to shifting. As a result, the shifting duration becomes longer (the shifting does not end at T (14)), and the inertia phase (shifting) ends at time T(24).

Further, since oil pressure of a level to have transmission torque is not supplied to both the on-coming clutch and off-going clutch from time T (23) to time T (25) as shown in FIG. 6, both clutches take a disengaged state. Therefore, if accelerator pedal 8008 is further stepped down by the driver during the period from time T (23) to time T (25), turbine racing (sudden increase of turbine speed NT) occurs to cause shift shock and/or longer shift duration.

Thus, according to a control device of the present invention, power-off upshift of clutch-to-clutch can be executed rapidly and without occurrence of shift shock.

In the case where it is difficult to avoid tie-up based on a setting of controlled oil pressure P (12), and tie-up is to be avoided more reliably, the control set forth above is preferably executed limited to the case where engine 1000 takes a driven state or a light driving state. In this case, determination is made of a driven state or light driving state of engine 1000, and the program represented by the flowchart set forth above is to be executed only when in such a state.

It should be understood that the embodiments disclosed herein are illustrative and non-restrictive in every respect. The scope of the present invention is defined by the appended claims, rather than the description set forth above, and all changes that fall within limits and bounds of the claims, or equivalence thereof are intended to be embraced by the claims.

1. A control device for an automatic transmission controlling release and engagement of different frictional engagement elements to execute engagement-switching shift, comprising:
an off-going side oil pressure controller controlling oil pressure of an off-going frictional engagement element,
an on-coming side oil pressure controller controlling oil pressure of an on-coming frictional engagement element, and
a control unit controlling said off-going side oil pressure controller and said on-coming side oil pressure controller,
said control unit determining whether said on-coming frictional engagement element is in a state having torque capacity, and detecting a request for said engagement-switching shift, and when a request for said engagement-switching shift is detected, modifying the oil pressure of said off-going frictional engagement element towards a releasing direction to a level of a predetermined releasing oil pressure causing a coupling force of said off-going frictional engagement element to attain a predetermined off-going side coupling force, while modifying the oil pressure of said on-coming frictional engagement element towards an engagement direction to a level of a predetermined engagement oil pressure causing a coupling force of said on-coming frictional engagement element to attain a predetermined on-coming side coupling force, and when determination is made that said on-coming frictional engagement element is in a state having torque capacity in response to modification in the oil pressure of said on-coming frictional engagement element, controlling the oil pressure of said on-coming frictional engagement element such that said on-coming frictional engagement element maintains a state having torque capacity, while modifying the oil pressure of said off-going frictional engagement element towards the releasing direction as compared with said predetermined releasing oil pressure such that the coupling force of said off-going frictional engagement element further becomes lower than said predetermined off-going side coupling force, wherein
said predetermined off-going side coupling force includes a level at which said off-going frictional engagement element does not slip when said on-coming frictional engagement element does not have torque capacity, and
said predetermined on-coming side coupling force includes a level at which said on-coming frictional engagement element has torque capacity.

2. The control device for an automatic transmission according to claim 1,
wherein said control unit releases said off-going frictional engagement element by modifying the oil pressure of said off-going frictional engagement element towards the releasing direction as compared with the level of said predetermined releasing oil pressure with a point of time of determining that said on-coming frictional engagement element is in a state having torque capacity as a starting point to release said off-going frictional engagement element, and controls an inertia phase time in said engagement-switching shift by modifying the oil pressure of said on-coming frictional engagement element after said off-going frictional engagement element is released.

3. (canceled)

4. The control device for an automatic transmission according to claim 1, wherein
said automatic transmission is coupled with an engine,
said control unit detects a state of said engine, and when said engine is in a driven state, controls said off-going side oil pressure controller and said on-coming side oil pressure controller.

5. The control device for an automatic transmission according to claim 1, wherein said control unit detects a request for upshift in a power-off state.

6. A control device for an automatic transmission controlling release and engagement of different frictional engagement elements to execute engagement-switching shift, comprising:
off-going side oil pressure control means for controlling oil pressure of an off-going frictional engagement element,
on-coming side oil pressure control means for controlling oil pressure of an on-coming frictional engagement element, and
determination means for determining whether or not said on-coming frictional engagement element is in a state having torque capacity,
detection means for detecting a request for said engagement-switching shift, and
control means for controlling said off-going side oil pressure control means and said on-coming side oil pressure control means,
said control means including
first means for, when said request for engagement-switching shift is detected, modifying the oil pressure of said off-going frictional engagement element towards a releasing direction to a level of a predetermined releasing oil pressure causing a coupling force of said off-going frictional engagement element to attain a predetermined off-going side coupling force, while modifying the oil pressure of said on-coming frictional engagement element towards an engagement direction to a level of a predetermined engagement oil pressure causing a coupling force of said on-coming frictional engagement element to attain a predetermined on-coming side coupling force, and
second means for, when determination is made that said on-coming frictional engagement element is in a state having torque capacity by said determination means in response to modification in the oil pressure of said on-coming frictional engagement element by said first means, controlling the oil pressure of said on-coming frictional engagement element such that said on-coming frictional engagement element maintains a state having torque capacity, while modifying the oil pressure of said off-going frictional engagement element towards the releasing direction as compared with said predetermined releasing oil pressure such that the coupling force of said off-going frictional engagement element further becomes lower than said predetermined off-going side coupling force, wherein
said predetermined off-going side coupling force includes a level at which said off-going frictional engagement element does not slip when said on-coming frictional engagement element does not have torque capacity, and
said predetermined on-coming side coupling force includes a level at which said on-coming frictional engagement element has torque capacity.

7. The control device for an automatic transmission according to claim 6,
wherein said second means releases said off-going frictional engagement element, by modifying the oil pressure of said off-going frictional engagement element towards the releasing direction as compared with the level of said predetermined releasing oil pressure with a point of time of determining that said on-coming frictional engagement element is in a state having torque capacity as a starting point to release said off-going frictional engagement element, and controls an inertia phase time in said engagement-switching shift by modifying the oil pressure of said on-coming frictional engagement element after said off-going frictional engagement element is released.

8. (canceled)

9. The control device for an automatic transmission according to claim 6, wherein said automatic transmission is coupled with an engine,
said control device further comprising means for detecting a state of said engine,
said control means including means for controlling said off-going side oil pressure control means and said on-coming side oil pressure control means when said engine is in a driven state.

10. The control device for an automatic transmission according to claim 6, wherein said detection means includes means for detecting a request of upshift in a power-off state.
